(19) United States
(12) Patent Application Publication
(10) Pub. No.: US 2021/0153718 A1
(43) Pub. Date: May 27, 2021

(54) TAPE CLEANER

(71) Applicant: KWANGJIN IND. CO., LTD., Gyeongsan-si (KR)

(72) Inventors: Hyeong-Cheol HWANG, Gyeongsan-si (KR); Sung-Mi JUNG, Busan (KR); Young-Im CHO, Gyeongsan-si (KR); Heon-Joo JEONG, Gyeongsan-si (KR)

(73) Assignee: KWANGJIN IND. CO., LTD., Gyeongsan-si (KR)

(21) Appl. No.: 16/944,329

(22) Filed: Jul. 31, 2020

(30) Foreign Application Priority Data
Nov. 26, 2019 (KR) 10-2019-0152908

(51) Int. Cl. A47L 25/00

(52) U.S. Cl. CPC A47L 25/005

(57) ABSTRACT

A tape cleaner is proposed. In the tape cleaner, the structure of the cleaner is simple, weight and volume thereof are minimized, the generation of noise is reduced during use, and the process of replacing an adhesive tape roll is performed rapidly and easily. The tape cleaner includes: an adhesive tape roll on which an adhesive tape is wound; a roll fitting part over which the adhesive tape roll is fitted; a handle part provided at a side of the roll fitting part; a roll-rotation guide part provided on the roll fitting part to guide rotational movement of the adhesive tape roll; and a noise reduction part provided in the roll fitting part to discharge and reduce noise generated during the rotational movement of the adhesive tape roll.

### CROSS REFERENCE TO RELATED APPLICATION

The present application claims priority to Korean Patent Application No. 10-2019-0152908, filed Nov. 26, 2019, the entire contents of which is incorporated herein for all purposes by this reference.

### BACKGROUND OF THE INVENTION

### Field of the Invention

The present invention generally relates to a tape cleaner. More particularly, the present invention relates to a tape cleaner, wherein the structure is simple, weight and volume are minimized, the generation of noise is reduced during use, and the process of replacing an adhesive tape roll is performed rapidly and easily.

### Description of the Related Art

Generally, as for articles made of fabrics, such as clothes and carpets, many contaminants adhere to the surface of the articles due to static electricity generated in the articles and contact of the articles with the contaminants during use.

Conventionally, an adhesive tape wound in the shape of a roll was used to remove various contaminants adhering to clothing and carpets, or hair that fell on the floor. However, in the state in which foreign matter adheres to the adhesive surface of the adhesive tape, a user is required to cut a contaminated portion of the adhesive tape by using a cutting tool such as a knife or scissors to use the adhesive tape, and the process of finding the end of the adhesive tape and removing the contaminated portion of the adhesive tape from the adhesive tape was very inconvenient.

To solve such a problem, as disclosed in Korean Patent No. 10-1199838, a tape cleaner has been developed and used.

As illustrated in FIG. 1, the tape cleaner described above is configured to include a cylindrical roll tape 110 on which an adhesive tape 111 is wound in multiple layers to allow contaminants such as dust or hair to adhere thereto; a rotating roller 120 having a rotating shaft 121 provided therein such that the roll tape 110 is fitted over the rotating roller and is rotated; a manipulation handle 130 provided at an end of the rotating shaft 121 to rotate the rotating roller 120; a cylindrical dust removal means 140 in which the roll tape 110 fitted over the rotating roller 120 is received such that the adhesive tape 111 released from the roll tape 110 is covered by an outer surface of the dust removal means, and an adhesive portion of the adhesive tape is exposed to the outside.

In addition, the rotating roller 120 is provided with a first band 122 inserted to an outer side of the dust removal means 140 from a side surface thereof, and a second band 123 inserted to an inner side of the dust removal means 140 from the side surface thereof to support the roll tape 110.

Furthermore, the rotating roller 120 has a slot 126 provided therein in a longitudinal direction of the rotating shaft 121 therealong inserted into the center portion thereof, wherein an adhesive tape support 150 is inserted to and provided in the slot 126, and winds the adhesive tape one time on the outer circumferential surface of the dust removal means 140 in a reverse or forward direction by pulling an end portion of the adhesive tape 111, the adhesive tape support being attached to and detached from the end portion of the dust removal means to fix the adhesive tape thereto.

In the tape cleaner according to Korean Patent No. 10-1199838, which is described above, contaminants adhering to the adhesive tape 111 due to the adhesive force thereof are easily removed while the roll tape 110 fitted over the rotating roller 120 rotates, but the following problems occur.

First, since the tape cleaner disclosed in Korean Patent No. 10-1199838 is configured to include the rotating roller 120, the rotating shaft 121, the first band 122, the second band 123, the manipulation handle 130, the dust removal means 140, and the adhesive tape support 150, there are too many components and is complicated in structure. Accordingly, manufacturing cost is increased due to the increase of man-hours and the number of manufacturing works, and the excessive number of required raw materials, so the burden of consumers are increased.

In addition, the tape cleaner disclosed in Korean Patent No. 10-1199838 has a large volume, and the rotating shaft 121 is made of metal, so due to the increase of weight, usability, storage, and handling are degraded.

Furthermore, according to the tape cleaner disclosed in Korean Patent No. 10-1199838, disassembling and assembling processes are complicated, and replacing the wound roll tape for refilling is difficult and inconvenient, so convenience in use is deteriorated.

### Documents of Related Art

(Patent Document 1) Korean Patent No. 10-1199838 “TAPE CLEANER HAVIG SIMPLY USED AND STORED ADHESIVE SURFACE”;

(Patent Document 2) Korean Patent No. 10-1194050 “TAPE CLEANER HAVING EASILY CUT TAPE”; and

(Patent Document 3) Korean Patent No. 10-1515052 “TAPE CLEANER HAVING EASILY EXCHANGEABLE ROLL TAPE”.

### SUMMARY OF THE INVENTION

Accordingly, the present invention has been made keeping in mind the above problems occurring in the related art, and the present invention is intended to propose a tape cleaner, wherein the structure is simple, and weight and volume are minimized so that convenience in use is improved, and manufacturing cost is reduced.

The present invention is further intended to propose a tape cleaner, wherein the generation of noise is reduced during use, and the process of replacing an adhesive tape roll is performed rapidly and easily.

In order to achieve the above objective, according to one aspect of the present invention, there is provided a tape cleaner including: an adhesive tape roll on which an adhesive tape is wound; a roll fitting part over which the adhesive tape roll is fitted; a handle part provided at a side of the roll fitting part; a roll-rotation guide part provided on the roll fitting part to guide rotational movement of the adhesive tape roll; and a noise reduction part provided in the roll fitting part to discharge and reduce noise generated during the rotational movement of the adhesive tape roll.

The roll-rotation guide part may be configured as a plurality of guide rings, the guide rings protruding on an outer circumferential surface of the roll fitting part and being spaced apart from each other.

Here, each of the guide rings may be configured as a circular ring having a linear structure, each of the guide rings being in linear contact with an inner circumferential surface of the adhesive tape roll to minimize generation of noise.

The noise reduction part may include a plurality of noise transmission holes formed through the outer circumferential surface of the roll fitting part, and a noise removal hole formed inside the roll fitting part in a longitudinal direction thereof to communicate with the noise transmission holes.

Here, the noise transmission holes may be formed between the guide rings along circumferential directions of the guide rings.

The roll fitting part and the handle part may be configured as a single body, the handle part having an auxiliary noise removal hole therein in a longitudinal direction thereof such that the auxiliary noise removal hole communicates with the noise removal hole.

Meanwhile, the roll fitting part may include: a fitting body configured as a cylindrical shape; a holding step protruding at an inner end of the fitting body; an elastic transformation part provided at an outer end portion of the fitting body to guide the fitting of the adhesive tape roll; and a removal prevention part famed at the outer end portion of the fitting body to prevent the adhesive tape roll from being removed from the roll fitting part.

The elastic transformation part may include groove parts recessed in the outer end portion of the fitting body, and elastic transforming protrusion parts protruding in the outer end portion of the fitting body at positions between the groove parts.

The removal prevention part may be configured as a removal prevention protrusion having a fitting-side inclined surface inclined in a roll-fitting direction to allow the adhesive tape roll to slide when the adhesive tape roll is fitted over the roll fitting part, and a removing-side inclined surface inclined in a roll-removing direction to allow the adhesive tape roll to slide when the adhesive tape roll is removed therefrom.

The handle part may include: a curved connection part extending curvedly from the roll fitting part; and a handle body extending from the curved connection part.

According to the tape cleaner of the present invention, the roll fitting part and the handle part are configured as a single body, thereby reducing manufacturing cost due to the simplicity of the structure, and increasing convenience in use due to light weight and minimized volume.

In addition, according to the tape cleaner of the present invention, the adhesive tape roll is in linear contact with the guide ring, and thus allows friction to be minimized during rotation, and noise to be reduced due to the noise reduction part, thereby improving marketability.

Furthermore, according to the tape cleaner of the present invention, it is easy to install and remove the adhesive tape roll due to elastic transformation of the elastic transformation part, thereby making the replacement process of the adhesive tape roll rapid and simple, and allowing stable and fixed state thereof to be maintained due to the removal prevention part.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is a view illustrating a conventional tape cleaner;

FIG. 2 is a perspective view illustrating a tape cleaner according to a first embodiment of the present invention;

FIG. 3 is an exploded perspective view illustrating the tape cleaner according to the first embodiment of the present invention;

FIGS. 4A and 4B are perspective views illustrating important components of the tape cleaner according to the first embodiment of the present invention;

FIG. 5 is an enlarged perspective view illustrating an important part of an elastic transformation part of the tape cleaner according to the first embodiment of the present invention;

FIG. 6 is an enlarged perspective view illustrating an important part of a roll-rotation guide part of the tape cleaner according to the first embodiment of the present invention;

FIG. 7 is a perspective view illustrating a state of a tape cleaner from which an adhesive tape roll is removed according to a second embodiment of the present invention; and

FIG. 8 is a perspective view illustrating the tape cleaner according to the second embodiment of the present invention.

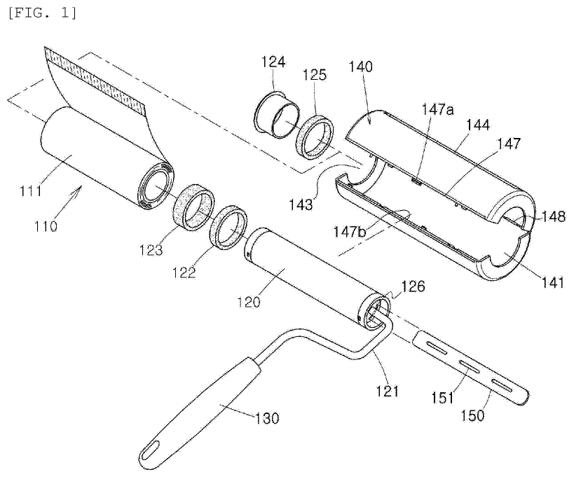

### DETAILED DESCRIPTION OF THE INVENTION

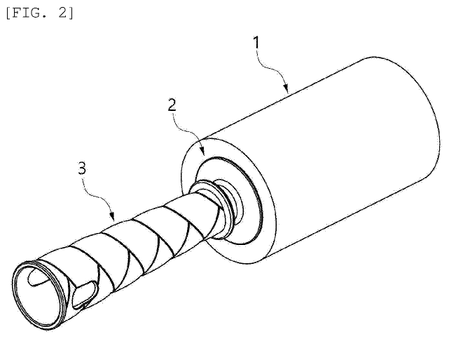

Hereinbelow, an exemplary embodiment of the present invention will be described in detail with reference to FIGS. 2 to 8. In FIGS. 2 to 8, the same reference numerals are assigned to the same components to be described.

Meanwhile, the detailed description of the configuration of each drawing and its operation and effects, which are easily understood by those skilled in the art to which the present invention belongs, will be simplified or omitted. In addition, since the present invention is characterized by a tape cleaner, the tape cleaner is illustrated and described focusing on parts related thereto, and descriptions of the remaining parts are simplified or omitted.

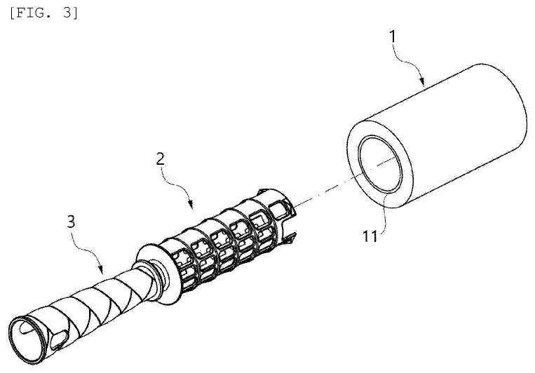

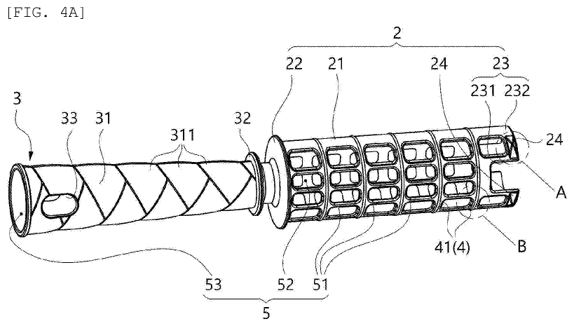

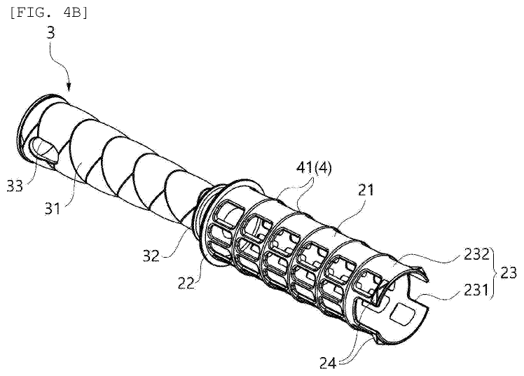

FIG. 2 is a perspective view illustrating a tape cleaner according to a first embodiment of the present invention; FIG. 3 is an exploded perspective view illustrating the tape cleaner according to the first embodiment of the present invention; and FIGS. 4A and 4B are perspective views illustrating important components of the tape cleaner according to the first embodiment of the present invention, wherein FIG. 4A illustrates a shape of the tape cleaner viewed from a first side, and FIG. 4B illustrates a shape of the tape cleaner viewed from a second side.

Referring to FIGS. 2 to 4B, the tape cleaner according to the first embodiment of the present invention includes an adhesive tape roll 1, a roll fitting part 2 over which the adhesive tape roll 1 fitted, and a handle part 3 provided at a side of the roll fitting part 2, and has a simple structure. The roll fitting part 2 and the handle part 3 are configured as a single body to minimize weight and volume.

In addition, the tape cleaner according to the first embodiment of the present invention is configured to include a roll-rotation guide part 4 and a noise reduction part 5 so as to reduce the generation of noise during use.

The adhesive tape roll 1 is configured in the shape of a roll by winding an adhesive tape having an adhesive layer provided on a surface thereof in multiple layers, and has a center roll 11 on which the adhesive tape is wound, the center roll being provided at the center of the adhesive tape roll and having a cylindrical shape made of paper.

Meanwhile, the roll fitting part 2 is a part over which the adhesive tape roll 1 is fitted, and is configured in an approximately cylindrical shape.

In more detail, the roll fitting part 2 is provided with a fitting body 21 formed in a cylindrical shape; a holding step 22 provided at the inner end of the fitting body 21 by protruding therefrom and formed in an approximately disc shape; an elastic transformation part 23 provided at an end portion of the fitting body to guide the fitting of the adhesive tape roll 1; and a removal prevention part 24 formed at the outer end portion of the fitting body 21 to prevent the adhesive tape roll 1 from being removed from the roll fitting part.

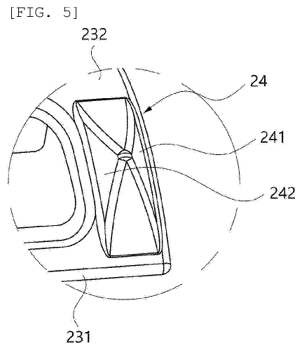

FIG. 5 is an enlarged perspective view illustrating an important part of the elastic transformation part of the tape cleaner according to the first embodiment of the present invention.

Referring to FIGS. 4A and 4B, the elastic transformation part 23 is configured to include groove parts 231 recessed in a “U” shape from the outer end portion of the fitting body, and a pair of elastic transforming protrusion parts 232 being in contact with each of the groove parts 231 and protruding from the height of an inner end thereof to the outer end portion of the fitting body to face each other.

The removal prevention part 24 is configured as a removal prevention protrusion having the shape of an approximately square pyramid, the removal prevention protrusion including: a fitting-side inclined surface 241 for the fitting inclined in a roll-fitting direction to allow the adhesive tape roll 1 to slide when the adhesive tape roll 1 is fitted over the roll fitting part 2; and a removing-side inclined surface 242 for the removal inclined in a roll-removing direction to allow the adhesive tape roll 1 to slide when the adhesive tape roll 1 is removed therefrom.

The handle part 3 protrudes integrally from the side of the roll fitting part 2 to be grasped by a user. A handle body 31 is configured as a roughly cylindrical shape, and includes a non-slip corrugated part 311 provided on an outer circumferential surface thereof. A handle step 32 is provided at an inner side of the handle body 31 by protruding therefrom and a holding hole 33 for holding is provided by being formed through an outer side of the handle body 31.

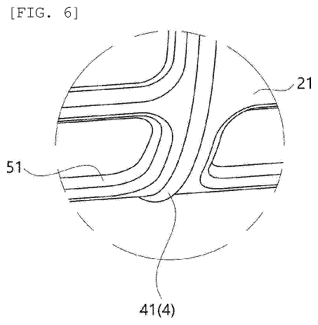

FIG. 6 is an enlarged perspective view illustrating an important part of the roll-rotation guide part of the tape cleaner according to the first embodiment of the present invention.

Referring to FIG. 6, the roll-rotation guide part 4 is a component provided on the roll fitting part 2 to guide the rotational movement of the adhesive tape roll 1, and is configured to include a plurality of guide rings 41 provided on the outer circumferential surface of the roll fitting part 2 by protruding therefrom to be spaced apart from each other.

Here, each of the guide rings 41 is characterized in that the guide ring is configured to minimize noise which may be caused by friction due to the rotation of the adhesive tape roll 1. To this end, the guide ring 41 is configured as a circular ring having a linear structure to be in linear contact with the inner circumferential surface of the adhesive tape roll 1.

The noise reduction part 5 is a component provided in the roll fitting part 2 to discharge and reduce noise generated during the rotational movement of the adhesive tape roll 1, and includes a plurality of noise transmission holes 51 formed through the outer circumferential surface of the roll fitting part 2, and a noise removal hole 52 formed inside the roll fitting part 2 in a longitudinal direction thereof to communicate with each of the noise transmission holes 51.

The noise transmission holes 51 are formed through the outer circumferential surface of the fitting body 21 located between the guide rings 41 at predetermined intervals in a circumferential direction thereof.

In addition, the handle part 3 is configured to have an auxiliary noise removal hole 53 formed therein in a longitudinal direction thereof, the auxiliary noise removal hole communicating with the noise removal hole 52, so that resonance phenomenon is prevented and noise is reduced.

Hereinafter, the operation of the tape cleaner according to the first embodiment of the present invention will be briefly described.

When the tape cleaner according to the first embodiment of the present invention is used, the adhesive tape roll 1 for refilling removed from the roll fitting part 2 as illustrated in FIG. 3 is fitted over the roll fitting part 2, and assembled therewith in a shape illustrated in FIG. 2. Such an assembling process will be described in more detail below. When a user applies a pressing force to the elastic transforming protrusion parts 232 in the central axis direction of the fitting body 21, the elastic transforming protrusion parts 232 are transformed to be brought together in the central axis direction relative to the groove part 231, and thus the size of the outer diameter of the fitting body is decreased. In this case, when a pressing force is applied to the adhesive roll 1 while the adhesive tape roll 1 is arranged to be coaxial to the fitting body 21, the adhesive roll 1 is slid on the fitting-side inclined surface 241 of the removal prevention part 24, and is efficiently fitted over the roll fitting part 2.

When the pressing force is released at the same time when the adhesive tape roll 1 is fitted over the roll fitting part 2, the elastic transforming protrusion parts 232 which are transformed are restored to initial states thereof by being stretched, and the outer end portion of the adhesive tape roll 1 is held by the removal prevention part 24. Accordingly, the adhesive tape roll 1 is held in the roll fitting part 2 so that the adhesive tape roll 1 is not removed therefrom.

As described above, when a user grips the handle part 3 and applies a moving force thereto in a state in which the adhesive tape roll 1 is in surface contact with a contaminated garment or carpet with the adhesive tape roll 1 assembled with the roll fitting part 2, the center roll 11 of the adhesive tape roll 1 is rotated while being guided by the guide ring 41, and foreign matter adheres to the adhesive surface of the adhesive tape and is removed from the garment or carpet. In this case, the guide ring 41 is configured as the circular ring having the linear structure, and is in linear contact with the inner circumferential surface of the adhesive tape roll 1, so the generation of noise can be minimized.

In addition, although small noise occurs during the rotation of the adhesive tape roll 1 described above, the noise can be reduced due to noise reduction action of the noise reduction part 5. Such a noise reduction action will be described more specifically below. Although small noise occurs due to the linear contact of the adhesive tape roll with the guide ring 41 during the rotation of the adhesive tape roll 1, the noise is through the multiple noise transmission holes 51 transmitted to the noise removal hole 52 communicating therewith to be spread, and is reduced. In this case, the noise removal hole 52 has a structure of being open in opposite sides thereof, and thus resonance phenomenon does not occur, thereby reducing noise.

In addition, in the case that the adhesive tape wound on the adhesive tape roll 1 is replaced after being completely used, when a force of pulling the adhesive tape roll 1 to the outside is applied thereto after the elastic transforming protrusion parts 232 are transformed to be brought together in the central axis direction, the adhesive tape roll 1 is slid on the removing-side inclined surface 242 of the removal prevention part 24 and is efficiently removed from the roll fitting part 2. When the removal process of the used adhesive tape roll is completed, the fitting of an adhesive tape roll 1 for refilling is performed, so that the tape cleaner of the present invention can be used repeatedly and conveniently.

Hereinafter, a second embodiment according to the present invention will be described, but the detailed description of components similar to the components shown in the above-described first embodiment will be omitted, and components having differences will be mainly described. In addition, in the following second embodiment, structures that can be adopted in the components shown in the first embodiment may be selectively applied, and the detailed description thereof or the illustration thereof in the drawings is omitted.

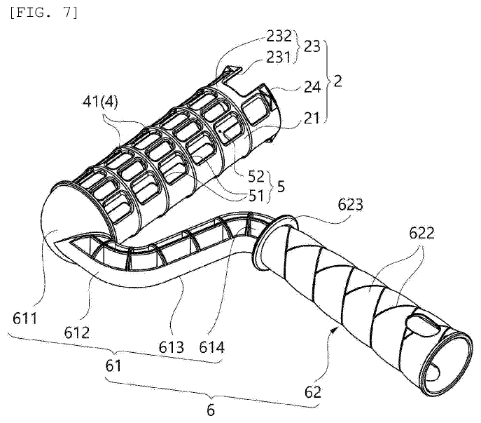

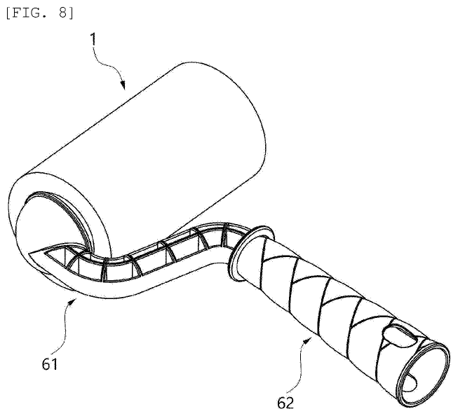

FIG. 7 is a perspective view illustrating the state of a tape cleaner from which an adhesive tape roll is removed according to the second embodiment of the present invention, and FIG. 8 is a perspective view illustrating the tape cleaner according to the second embodiment of the present invention.

Referring to FIGS. 7 and 8, the tape cleaner according to the second embodiment of the present invention includes the adhesive tape roll 1, a roll fitting part 2 over which the adhesive tape roll 1 is fitted, and a handle part 6, wherein the handle part 6 is curved so that a direction in which a user grips a handle body has a predetermined angle with respect to the roll fitting part 2 for convenience in use.

The handle part 6 is configured to include a curved connection part 61 extending curvedly from the roll fitting part 2, and the handle body 62 extending from the curved connection part 61.

The curved connection part 61 is configured to include a connecting protrusion part 611 provided at the end portion of a side of the roll fitting part 2; a first curved portion 612 extending from the connecting protrusion part 611 in a direction orthogonal to the roll fitting part 2; a second curved portion 613 extending slantingly from the first curved portion 612 to have an obtuse angle with respect thereto, and a third curved portion 614 extending from the second curved portion 613 in a direction orthogonal to the roll fitting part 2.

The handle body 62 is configured as an approximately cylindrical shape, and includes a non-slip corrugated part 622 provided on an outer circumferential surface thereof. The handle body 62 is provided by extending in the shape of a straight line from the third curved portion 614 described above. Furthermore, a handle step 623 is provided at a boundary portion between the handle body 62 and the third curved portion 614 by protruding therefrom to prevent the hand of a user from slipping.

In addition, while the handle part 6 described above is provided by extending curvedly from the roll fitting part 2, the overall shape of the tape cleaner is configured to be approximately T-shaped, but is not limited thereto, and can be configured by being changed to various shapes.

Meanwhile, in the tape cleaner according to the second embodiment of the present invention, the handle body 62 which a user grips is configured in an angle orthogonal to the roll fitting part 2, and allows the adhesive tape roll 1 to be rotated by the forward and backward movements thereof, so that contaminants can be removed more conveniently.

Furthermore, the roll fitting part 2, the roll-rotation guide part 4, and the noise reduction part 5 applied to the tape cleaner according to the second embodiment of the present invention are configured similarly to the first embodiment described above, and thus the detailed description of the detailed configuration thereof, or the operational effect thereof is omitted.

The configuration and operation of the tape cleaner according to the embodiments of the present invention described above have been described, but the embodiments have been described for illustrative purposes. Those skilled in the art will appreciate that various modifications, additions, and substitutions are possible, without departing from the scope and spirit of the invention as disclosed in the accompanying claims.

Therefore, the protection scope of the present invention should be understood to affect the invention and its equivalents described in the claims.

What is claimed is:

1. A tape cleaner comprising:
an adhesive tape roll on which an adhesive tape is wound;
a roll fitting part over which the adhesive tape roll is fitted;
a handle part provided at a side of the roll fitting part;
a roll-rotation guide part provided on the roll fitting part to guide rotational movement of the adhesive tape roll; and
a noise reduction part provided in the roll fitting part to discharge and reduce noise generated during the rotational movement of the adhesive tape roll.

2. The tape cleaner of claim 1, wherein the roll-rotation guide part is configured as a plurality of guide rings, the guide rings protruding on an outer circumferential surface of the roll fitting part and being spaced apart from each other, and
the noise reduction part comprises a plurality of noise transmission holes formed through the outer circumferential surface of the roll fitting part, and a noise removal hole formed inside the roll fitting part in a longitudinal direction thereof to communicate with the noise transmission holes.

3. The tape cleaner of claim 2, wherein the roll fitting part and the handle part are configured as a single body, the handle part having an auxiliary noise removal hole therein in a longitudinal direction thereof such that the auxiliary noise removal hole communicates with the noise removal hole.

4. The tape cleaner of claim 2, wherein each of the guide rings is configured as a circular ring having a linear structure, each of the guide rings being in linear contact with an inner circumferential surface of the adhesive tape roll to minimize generation of noise, and
the noise transmission holes are formed between the guide rings along circumferential directions of the guide rings.

5. The tape cleaner of claim 2, wherein the roll fitting part comprises:
a fitting body configured as a cylindrical shape;
a holding step protruding at an inner end of the fitting body;
an elastic transformation part provided at an outer end portion of the fitting body to guide the fitting of the adhesive tape roll; and
a removal prevention part famed at the outer end portion of the fitting body to prevent the adhesive tape roll from being removed from the roll fitting part.

6. The tape cleaner of claim 5, wherein the elastic transformation part comprises groove parts recessed in the outer end portion of the fitting body, and elastic transforming protrusion parts protruding in the outer end portion of the fitting body at positions between the groove parts, and
the removal prevention part is configured as a removal prevention protrusion having a fitting-side inclined surface inclined in a roll-fitting direction to allow the adhesive tape roll to slide when the adhesive tape roll is fitted over the roll fitting part, and a removing-side inclined surface inclined in a roll-removing direction to allow the adhesive tape roll to slide when the adhesive tape roll is removed therefrom.

7. The tape cleaner of any one of claim 1, wherein the handle part comprises:
a curved connection part extending curvedly from the roll fitting part; and
a handle body extending from the curved connection part.
